(19) United States
(12) Patent Application Publication
(10) Pub. No.: US 2010/0064312 A1
(43) Pub. Date: Mar. 11, 2010

(54) METHOD, APPRARATUS AND SYSTEM FOR PLAYOUT DEVICE CONTROL AND OPTIMIZATION

(76) Inventors: Scott Francis, Danville, CA (US); Ranier Swing, VS-Villingen (DE)

Correspondence Address: Robert D. Shedd, Patent Operations;THOMSON Licensing LLC, P.O. Box 5312, Princeton, NJ, 08543-5312, US

(21) Appl. No.: 12/312,494

(22) PCT Filed: Dec. 4, 2007
(86) PCT No.: PCT/US2007/024811

§ 371 Date: May 13, 2009

Related U.S. Application Data
(60) Provisional application No. 60/872,908, filed on Dec. 5, 2006.

(51) Int. Cl. H04N 5/445; H04N 5/44; G06Q 30/00

(52) U.S. Cl. 725/37; 348/734; 705/14.4; 348/E05.096

(57) ABSTRACT

Embodiments of the present invention provide a method, apparatus and system for the control and optimization of playout devices such as displays and speakers. In various embodiments of the present invention, high definition multimedia interface (HDMI) applications are provided for communication between a control device and a content playout device for controlling the playout functionality of the content playout device using HDMI communication means and vendor specific commands. That is, associated control signals are provided for controlling or optimizing display and speaker settings for providing a desired viewing and listening experience. The concepts of the present invention provide for remote command of display functions and, in addition, for remote monitoring of display status and settings. In addition, applications are provided that lock out or limit the functionality of display and speaker controls from user inputs or settings.

### CROSS REFERENCE TO RELATED APPLICATIONS

This application claims the benefit of U.S. provisional patent application No. 60/872,908, filed Dec. 5, 2006, which is herein incorporated by reference in its entirety.

### FIELD OF THE INVENTION

The present invention generally relates to the control and optimization of playout devices and, more particularly, to a method and system for controlling and optimizing a playout device irrespective of user input or settings.

### BACKGROUND OF THE INVENTION

There has been much research and development over the years for attempting to optimize video and audio content on displays and other playout devices. For example, many forms of look-up-tables are currently used to attempt to modify and optimize the “look” of video content on particular displays with known visual characteristics. However, such look-up-tables can only assume that the visual characteristics of the specific displays and display types are optimized or remain in their “factory default” settings. Such is not always the case.

Display users tend to change factory settings including color, contrast, tint etc., to their personal preferences. As such, look-up-tables previously determined for optimized or factory default settings of a display do not always produce the best quality pictures on the display. For example, in a video-on-demand environment, a content broadcaster attempts to deliver video content in a form (i.e., using look-up-tables) that will look best on consumer displays. However, such video content can look less than optimal on displays that have settings that have been modified by a user.

In a retail environment, retailers have been unsatisfied with the limits of current technology available to control displays that are on display in their stores. Some problems include the inability to verify/force the displays into a power on state; the inability to verify/force a selected input/channel; the inability to verify/force the optimization of content on display, and the like. Such inabilities leave the retailers unable to control the merchandising experience in a uniform and optimized manner. Again, although displays in retail environments are configured for optimum viewing, display settings can be modified by consumers or other individuals coming in contact with the displays. For example, retail displays can be turned off by consumers, channels can be changed and color and contrast settings can be altered. The effect is that blank displays or ones showing poor quality content do not sell as well. In addition, advertising messages can be missed or not optimized for most effective viewing.

The video-on-demand environment and the retail environment are merely two example environments in which it is important to optimize displays and other playout devices, however many more such environments exist including the home environment, the work environment, and the like.

### SUMMARY OF THE INVENTION

Embodiments of the present invention address the deficiencies of the prior art by providing a method, apparatus and system for the control and optimization of playout devices such as displays and speakers.

In various embodiments of the present invention, high definition multimedia interface (HDMI) applications are provided for communication between a control device and a content playout device for controlling the playout functionality of the content playout device using HDMI communication means and vendor specific commands. In addition, applications are provided that lock out or limit the functionality of external controls of the playout device from user inputs or settings.

In one embodiment of the present invention, a method for controlling a content playout device includes establishing a communication between a control device and the content playout device using a high definition multimedia interface (HDMI) application and controlling playout functionality of the content playout device using the established HDMI communication and vendor specific commands. The method can optionally include communicating a query to the content playout device to determine playout parameters.

In an alternate embodiment of the present invention a system for controlling a content playout device includes an HDMI communication means, a control device for communicating control information including at least vendor specific commands to the playout device via the HDMI communication means and a playout control unit in communication with the content playout device for receiving the control information from the control device via the HDMI communication means and establishing playout functionality of the content playout device according to the control information.

In an alternate embodiment of the present invention, a control device for controlling a content playout device includes a memory for storing at least one of control programs and control information including vendor specific commands, media content and playout parameters of the content playout device and a processor for executing the control programs. The processor is configured to perform the step of communicating media content and control information to the content playout device over an established high definition multimedia interface (HDMI) communication means for controlling playout functionality of the content playout device using the established HDMI communication means and the control information.

In an alternate embodiment of the present invention, a content playout device includes a playout control unit including a memory for storing control programs and control information including vendor specific commands, media content and playout parameters of the content playout device and a processor for executing the control programs. In one embodiment, the processor is configured to perform the steps of receiving media content and control information from a control device over an established high definition multimedia interface (HDMI) communication means, and establishing playout functionality of the content playout device in accordance with the control information received from the control device.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a system for display control and optimization in accordance with an embodiment of the present invention;

FIG. 2 depicts a high level block diagram of an HDMI communication means suitable for use in the display control and optimization system of FIG. 1 in accordance with an embodiment of the present invention;

FIG. 3 depicts a high level block diagram of a system for the control and optimization of a display in accordance with an alternate embodiment of the present invention;

FIG. 4 depicts a high level block diagram of a playout control unit suitable for use in the system of FIG. 1 in accordance with an embodiment of the present invention;

FIG. 5 depicts a command byte structure overview in accordance with an embodiment of the present invention;

FIG. 6 depicts a table of exemplary Vendor specific commands for the command byte structure of FIG. 5 in accordance with an embodiment of the present invention and

FIG. 7 depicts a table of exemplary Vendor specific responses to the Vendor specific commands depicted in the table of FIG. 6.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for the control and optimization of playout devices. Although the present invention will be described primarily within the context of a retail advertising network environment using HDMI functionality and communication for controlling displays, the specific embodiments of the present invention should not be treated as limiting the scope of the invention. It will be appreciated by those skilled in the art and informed by the teachings of the present invention that the concepts of the present invention can be advantageously applied in substantially any content distribution environment for the control and optimization of not only displays but also any device capable of receiving and processing audio and/or video and or audio/video content (e.g., content playout device).

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

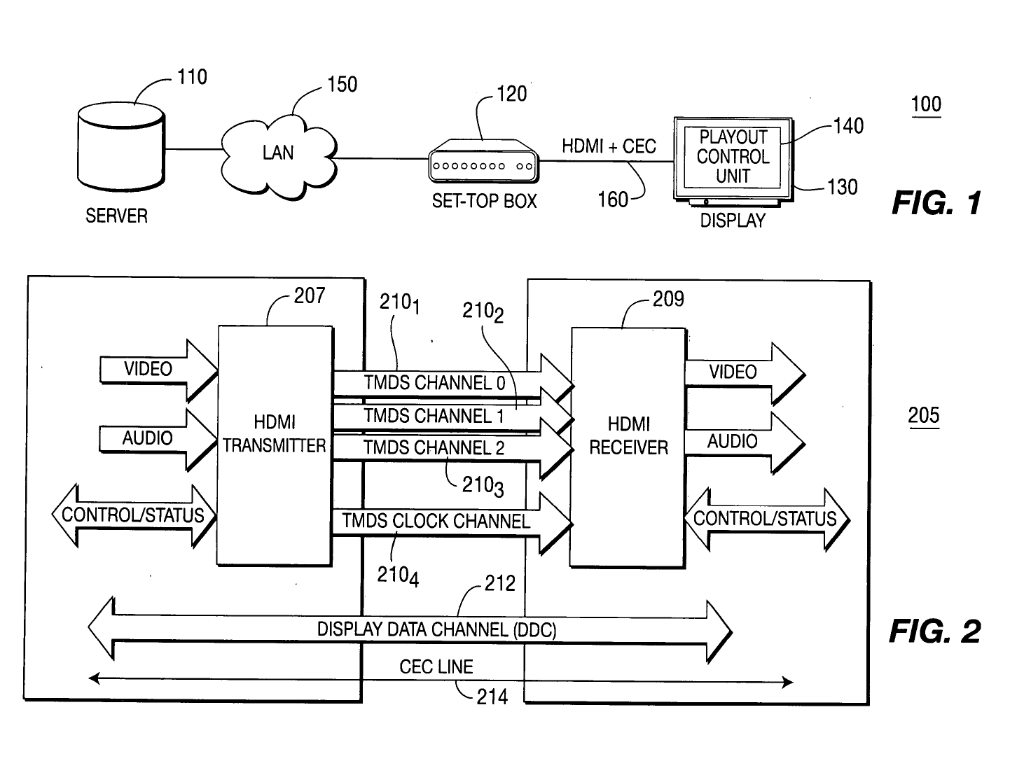

FIG. 1 depicts a high level block diagram of a system for the control and optimization of a playout device such as a display in accordance with an embodiment of the present invention. The system 100 of FIG. 1 illustratively comprises a server 110, a set-top box (STB) 120 and a display 130. In the system 100 of FIG. 1, the display 130 illustratively comprises a playout control unit 140. The system 100 of FIG. 1 further illustratively includes a Local Area Network (LAN) 150 and an HDMI (High Definition Multimedia Interface) communication means 160 with optional CEC (consumer electronic control) functionality. In the embodiment of FIG. 1, the server 110 provides video, audio and/or audio/video content to be streamed to the STB 120 over the LAN 150. For example, in one embodiment of a retail environment, the server 110 provides a plurality of media clips to be streamed to the STB 120. At the STB 120, the received streamed content (e.g., media clips) is communicated to the display 130 over the HDMI communication means 160. The playout control unit 140 of the display 130 receives the media clips and any other information (e.g., application and control signals described below with reference to vendor specific commands) from the STB 120. In various embodiments of the present invention, a server of the present invention can comprise a general purpose computer that is programmed to perform various control functions in accordance with the present invention.

Although the system 100 of FIG. 1 depicts a server in communication with a STB for communication with a display, in alternate embodiments of the present invention, a server can communicate directly with a display, the display having receiver (STB) functionality integrated. In addition, although the system 100 of FIG. 1 depicts the server and the STB/display in communication through a LAN, in alternate embodiments of the present invention, a server can be a local server to an STB/display and communicate directly with the STB/display. In addition, in an alternate embodiment of the present invention, the server can comprise a user interface (not shown) for communicating with a STB/display for performing the various aspects of the embodiments of the present invention described herein. Furthermore, although the system 100 of FIG. 1 depicts a control device (e.g., server) in control of a display, in alternate embodiments of the present invention, a control device, such as a server, can implement the aspects of the present invention for querying and controlling other devices capable of receiving and processing audio, video and/or audio/video content, such as a speaker or other content playout device. Although in the above described embodiment of the present invention, the system 100 of FIG. 1 depicts an HDMI communication means with optional CEC functionality, in alternate embodiments of the present invention, the HDMI communications means can implement another applications for providing high-level control functions.

In accordance with an embodiment of the present invention, the server 110 communicates a control signal(s) (e.g., command set) and/or an application(s) to the playout control unit 140 of the display 130 (or other content playout device), the application(s) and control signal(s) configured to query and control various functionalities of the display 130 over the HDMI communication means 160. For example, in one embodiment of the present invention, the server 110 communicates an application and associated control signals to the playout control unit 140 of the display 130 via the STB 120 and the HDMI communication means 160. The control signal(s) communicated to the playout control unit 140 of the display 130 from the server 110 can query the display regarding its current settings and configure the display settings to optimize a particular video clip or video clips associated or communicated with the control signal(s). Additionally, the control signal(s) can be further configured to optimize audio functionalities (e.g., volume, treble, bass, etc.) of the display 130, to optimize or control audio associated or communicated with the control signal(s). That is, in accordance with the various embodiments of the present invention, HDMI communication and functionality are used in conjunction with vendor specific commands for querying and controlling the various operating features of a playout device, such as the display 130.

In one embodiment of the present invention, the control signals are intended to disable the control buttons on the display and alternatively on a remote control for the display 130 as well. As such, a user is unable to turn the display on or off or adjust any of the viewing parameters (e.g., color, contrast, brightness, etc.) of the display 130. That is, for example, in a retail advertising environment it is advantageous to have a display optimized for the viewing content to be displayed for creating the best possible viewing experience for presenting, for example, retail advertising, or for attempting to present to a viewer the capabilities of that particular display for sale. As such, if a customer changes the display parameters of the display, the content on the display may not be optimized and may diminish the presentation thus diminishing the effectiveness of the advertising or not demonstrating the true capabilities of the display. As such, a display can be optimized according to the concepts of the various embodiments of the present invention and the display controls can be disabled such that a user is not able to negatively affect the display of the content.

FIG. 2 depicts a high level block diagram of an HDMI communication means 160 suitable for use in the display control and optimization system 100 of FIG. 1 in accordance with an embodiment of the present invention. The HDMI communication means 160 of FIG. 2 illustratively comprises an HDMI (High-Definition Multimedia Interface) cable 205 including an HDMI transmitter 207 and an HDMI receiver 209 connected via four connectors 210₁-210₄. The HDMI communication means 160 of FIG. 2 further includes a display data channel (DDC) connector 212 and a CEC (Consumer Electronics Control) connector 214.

In the embodiment of FIG. 2, the HDMI connection with implemented CEC 212 is used for controlling display and audio devices in accordance with the present invention. More specifically, the HDMI cable 205 and connectors 210 of the HDMI communication means 160 of FIG. 2 carry four differential pairs that make up the TMDS data and clock channels. These channels are used to carry video, audio and auxiliary data. In addition, the HDMI communication means 160 via the DDC connector 212 carries a DDC channel. The DDC channel is used for configuration and status exchange between a Source and a Sink. The optional CEC protocol of the embodiment of FIG. 2 provides high-level control functions between all of the various audiovisual devices (e.g., speakers, set-top boxes and associated displays and other content playout devices) in, for example, a content distribution environment.

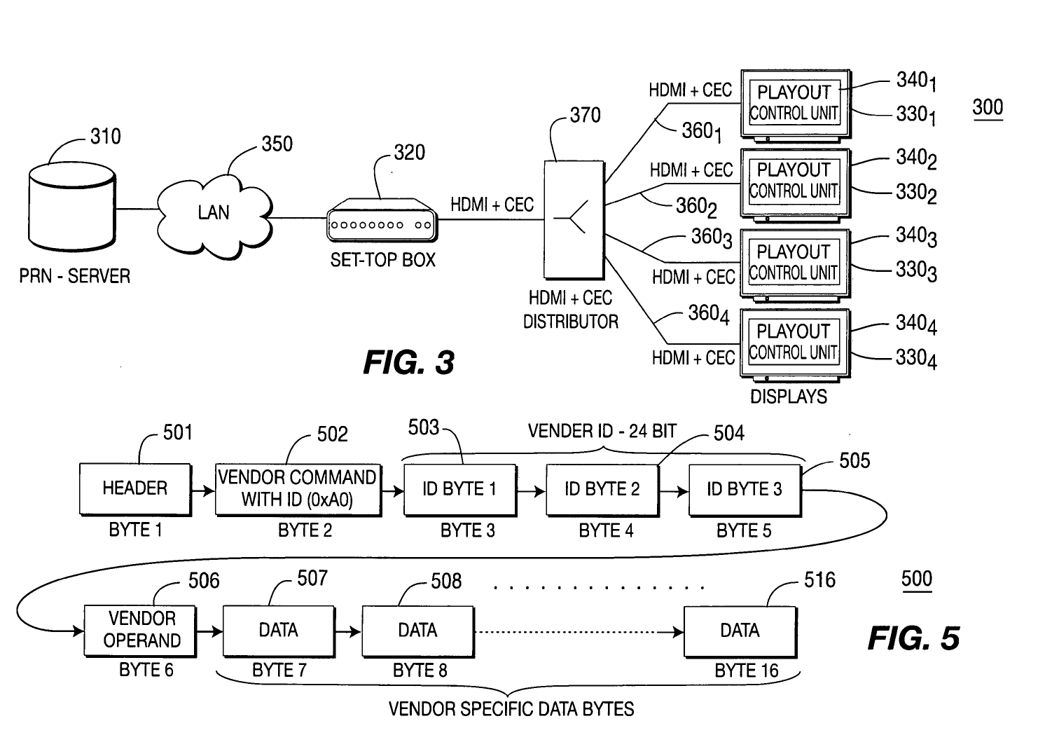

Although the receiver (e.g., display) control and optimization system 100 of FIG. 1 depicts a single display device 130 being controlled by a single STB 120, in alternate embodiments of the present invention, a STB can communicate and control a plurality of STBs. For example, FIG. 3 depicts a high level block diagram of a system for the control and optimization of a display in accordance with an alternate embodiment of the present invention. The system 300 of FIG. 3 illustratively comprises a server 310, a set-top box (STB) 320 and a plurality of displays 330₁-330₄. In the system 300 of FIG. 3, the displays 330 illustratively comprise respective playout control units 340₁-340₄. The system 300 of FIG. 3 further illustratively includes a Local Area Network (LAN) 350. The system 300 of FIG. 3 further includes an HDMI distribution means 370 and a respective HDMI communication means 360₁-360₄ for communication between the STB 320 and the respective playout control units 340₁-340₄ of the displays 330₁-330₄. Similarly and as previously described, in alternate embodiments of the present invention, the aspects of the present invention can be implemented to control a plurality of other content playout devices such as speakers.

In the embodiment of FIG. 3, the server 310 provides video, audio and/or audio/video content to be streamed to the STB 320 (or speakers, not shown) over the LAN 350. For example, in one embodiment of a retail environment, the server 310 provides a plurality of media clips to be streamed to the STB 320. At the STB 320, the received streamed content (e.g., media clips) is communicated to the displays 330 over the HDMI distribution means 370 and the respective HDMI communication means 360. The respective playout control units 340 of the displays 330 receive respective media clips and any other information (e.g., application and control signals described below) from the STB 320.

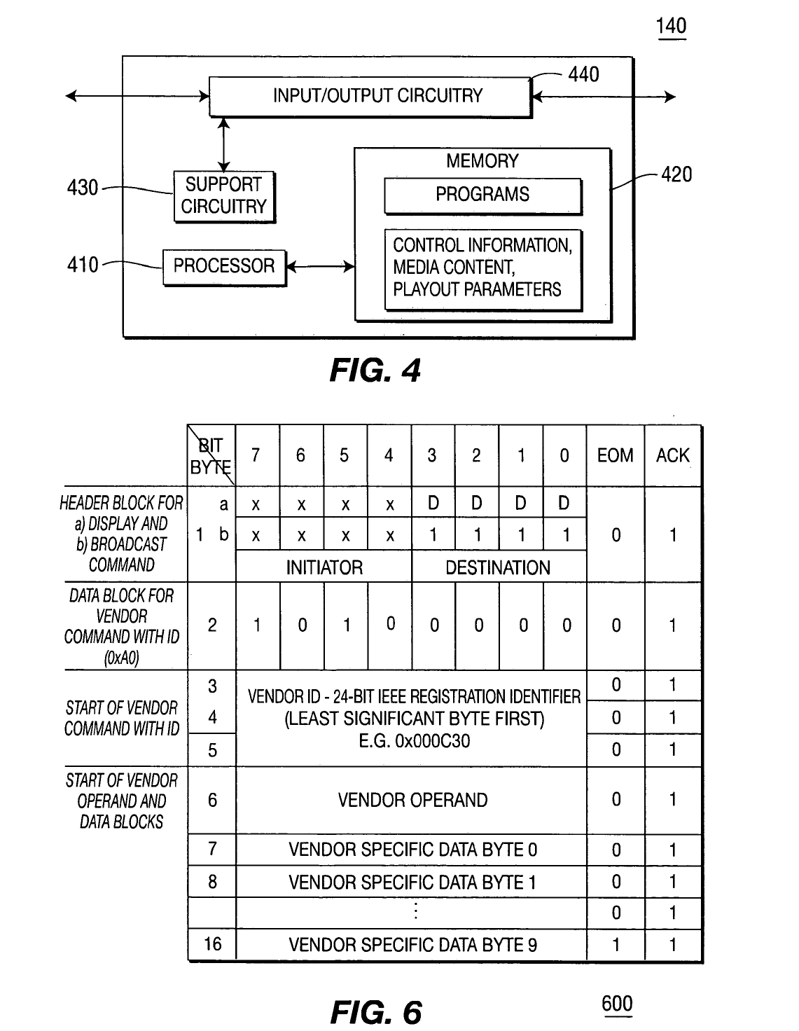

FIG. 4 depicts a high level block diagram of a playout control unit 140 suitable for use in the display 130 of the system for display control and optimization 100 of FIG. 1 in accordance with an embodiment of the present invention. The playout control unit 140 of FIG. 4 illustratively comprises a processor 410 as well as a memory 420 for storing control programs, applications, command sets, control information including vendor specific commands, media content, playout parameters and the like. The processor 410 cooperates with conventional support circuitry 430 such as power supplies, clock circuits, cache memory and the like as well as circuits that assist in executing the software routines stored in the memory 420. As such, it is contemplated that some of the process steps discussed herein as software processes may be implemented within hardware, for example, as circuitry that cooperates with the processor 410 to perform various steps. The playout control unit 140 of FIG. 4 also contains input-output circuitry 440 that forms an interface between the various respective functional elements communicating with the playout control unit 140.

Although the playout control unit 140 of FIG. 4 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof.

In the above described embodiments of the present invention such as the embodiment of FIG. 1, the concepts of the present invention can be applied using High-Definition Multimedia Interface (HDMI) capabilities. In the system of FIG. 1, the STB 120 and the display 130 (and as such the playout control unit 140 of the display) are configured with HDMI communication and control capabilities. More specifically, the HDMI standards allow for vendor specific applications and commands. As such, the server 110 can construct or configure an HDMI Application that when communicated to the playout control unit 140 of the display 130 by the STB 120 can optimize and/or control the display of associated video, audio and/or audio/video clips to be displayed on the display 130. As such, in accordance with the present invention, the settings of a display can be remotely controlled and determined via the HDMI Application despite user inputs or settings. In addition and as described above, the HDMI Application of the present invention can cause the functionality of all front panel buttons on the display 130 and control buttons on an associated remote control for the display 130 to be locked out or have limited control.

In one embodiment of the present invention, an ACK bit is used to acknowledge the data or header block. Typically the ACK bit is set to 1 by an initiator (e.g., control device such as the server 110 of FIG. 1) and can function in one of two modes:

1) For messages addressed to a single device:
A follower (e.g., a display having a playout control unit) that reads its own address in the destination address field shall acknowledge with a ‘0’ ACK bit.
All other devices shall generate a ‘1’ ACK bit (i.e. do nothing).
A ‘0’ read by the initiator therefore indicates a successful transmission of the data or header block.
   2) For broadcast messages the sense of the ACK bit is inverted to allow for a single device to reject a message:
All followers shall acknowledge with a ‘1’ ACK bit.
A ‘1’ read by the initiator therefore indicates that no device has rejected the data or header block—the message transmission can therefore continue if required.
A follower that wants to reject a broadcast message shall generate a “0” ACK bit.
A ‘0’ read by the initiator therefore indicates that one or more devices have rejected the message.

In one embodiment of the present invention, for low level features, there are three mechanisms to provide a reliable communications medium for the transfer of frames:
Frame re-transmissions increase the chance of a successful message transfer.
Flow control ensures that communication only progresses as fast as the slowest follower.
Frame validation.
   Given these mechanisms and the active ACK method, a message transmitted and acknowledged should be assumed correctly received. A message that does not result in a <Feature Abort> can be assumed to have been acted upon. In one embodiment of the present invention, a receiving device can make such an assumption after 1 second. Generally, however, the <Feature Abort> will be received within around 100 ms.

In one embodiment of the present invention, for frame re-transmissions, a frame is considered lost and therefore may be re-transmitted under the following conditions:
If a frame is not acknowledged in a directly addressed message.
If a frame is negatively acknowledged in a broadcast message.
If the initiator detects low impedance on the CEC line when it is transmitting high impedance and is not expecting a follower asserted bit.
   Re-transmission can be attempted, for example, up to 5 times for a single message and shall be attempted at least once. The re-try shall be after a signal free time.

In one embodiment of the present invention, to provide flow control, a receiving device can negatively acknowledge any data or header block it is at present unable to process. A negative acknowledge will cause re-transmission by the initiator.

In one embodiment of the present invention, for CEC line error handling, it is the responsibility of all receiving devices to detect the existence of spurious pulses on the control signal line and notify all other devices (primarily the initiator) that a potential error has occurred. An error can be defined as a period between falling edges that is less than a minimum data bit period (i.e. too short to be a valid bit). Errors can be notified by the receiving devices by generating a low bit period on the control signal line as a multiple of the nominal data bit period. After such an error notification the original initiator should stop sending its current frame and re-try later.

In one embodiment of the present invention, all devices support the message <Feature Abort>. It is used to allow devices to indicate if they do not support an op code that has been sent to them, if they are unable to deal with the message at present, or if there was something wrong with the transmitted frame at the high-level protocol layer. The Feature abort message has two parameters, the opcode and a reason for the rejection of the frame. The reaction to a faulty message by the follower depends on if the message was directed or broadcast.

For a broadcast message:
A follower that receives a broadcast message which it does not support, ignores the received message, and does not send a <Feature Abort>.
   For a directly addressed message:
<Feature abort> is used as a response to any failure.

In one embodiment of the present invention, if an initiator wishes to attempt retransmission after receiving a <Feature Abort>, the retransmission is delay, for example, for 200 ms. The delay will allow time for the follower to recover from the state that caused the initial <Feature Abort> message. The above describe features are merely a few examples of the possible features of the present invention. Further features in accordance with various embodiments of the present invention are described below.

For example, FIG. 5 depicts a command byte structure overview in accordance with an embodiment of the present invention. The command byte structure 500 of FIG. 5 illustratively comprises a first header byte 501, a second Vendor command with ID byte 502, three subsequent Vendor ID bytes 503, 504 and 505, a sixth Vendor Operand byte 506, and 10 subsequent Vendor Specific Data bytes 507-516.

FIG. 6 depicts a table 600 of exemplary Vendor specific commands for the command byte structure 500 of FIG. 5 in accordance with an embodiment of the present invention including EOM and ACK commands. As depicted in the exemplary embodiment of FIG. 6, the eight bits of the byte 1 of the command byte structure 500 can include a Header block for either a) a directly addressed receiver (e.g., a display) or b) a broadcast command. The eight bits of byte 2 of the command byte structure 500 define a data block for a Vendor Command with an ID (0xA0). The eight bits of bytes 3, 4 and 5 define a Vendor ID, for example, a 24-Bit IEEE Registration Identifier (e.g. 0x000C30). The eight bits of byte 6 of the command byte structure 500 include a Vendor operand, and the eight bits of bytes 7 through 16 include Vendor specific data.

Referring to FIG. 6, the EOM (End of Message) bit is used to indicate a block is the final block in the message. A ‘0’ bit specifies that one or more data blocks follow. A ‘1’ bit specifies that the message is complete. In the event that a message contains additional data blocks after an EOM is indicated, the receiver shall ignore the additional blocks. The ACK (Acknowledge) bit is used by receiver(s) to acknowledge the data or header block. It is always set to 1 by the sender. For messages addressed to a single device, a receiver that reads its own address in the destination address field shall acknowledge with a ‘0’ ACK bit. All other devices shall not assert the ACK bit to logical ‘0’. A ‘0’ read by the sender therefore indicates a successful transmission of the data or header block. For broadcast messages the sense of the ACK bit is inverted to allow for a single device to reject a message. All receivers that do not want to reject the message shall not assert the ACK bit to logical ‘0’. A ‘1’ read by the sender therefore indicates that no device has rejected the data or header block—the message transmission can therefore continue if required. A receiver that wants to reject a broadcast message shall generate a “0” ACK bit. A ‘0’ read by the sender therefore indicates that one or more devices have rejected the message.

The header block consists of the source logical address field, the destination logical address field, the end of message bit (EOM) and the acknowledge bit (ACK). The initiator (sender) logical address field is used to identify the initiator of the current frame. The logical address of the initiator is written in this field. The field consists of bits one to four of the header block, most significant bit first.

The destination logical address field is used to identify the destination of the current frame. The logical address of the destination is written in this field. For example, a special address (0b1111) can be used for broadcast messages. In one embodiment of the present invention, the field can consist of bits five to eight of the header block, most significant bit first.

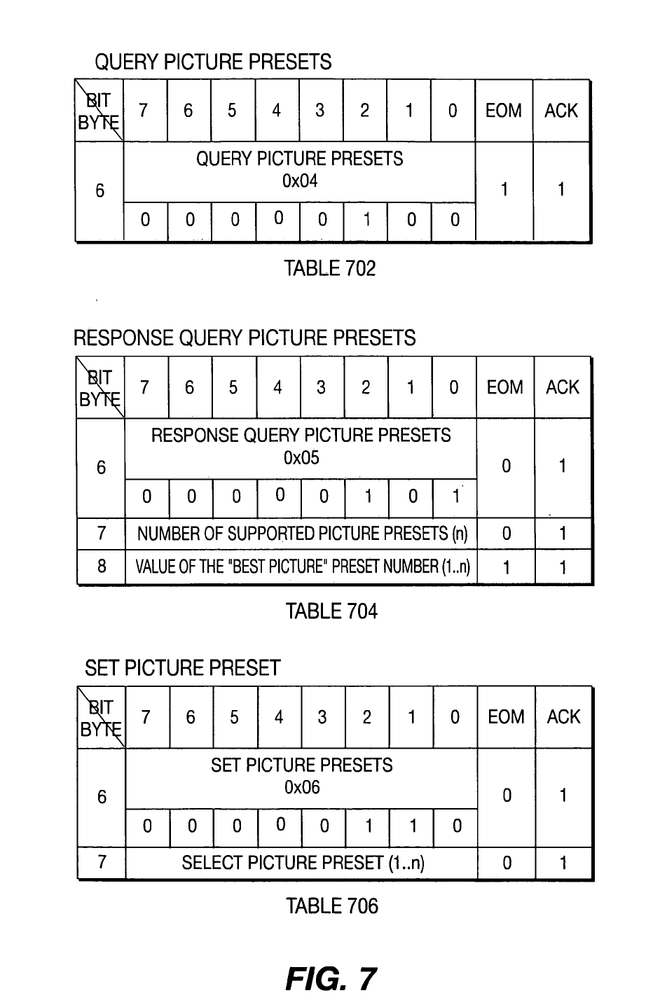

In accordance with the present invention, the Vendor specific commands as depicted in FIG. 5 and FIG. 6 above, can be used to Query and control the operating parameters of a receiver such as a display for setting such parameters using the Vendor specific commands via the HDMI functionality described herein. For example, FIG. 7 depicts respective tables for Vendor specific commands for a picture presets query, a response to the picture presets query and a setting of a selected picture preset. More specifically, in FIG. 7, table 702 depicts an exemplary vendor operand for a query requesting the number of supported picture presets and a number of a “best picture” preset for a subject display using, for example, byte 6 of the command byte structure 500 of FIG. 5. With reference to FIG. 1 and FIG. 7, in one embodiment of the present invention, the server 110 communicates a query to, for example, the display 130 and ultimately the playout control unit 140 of the display 130 for attempting to determine the number of supported picture presets for the display 130 and a number of a “best picture” preset for the display 130.

Referring back to FIG. 7, table 704 depicts an exemplary response from the display for communicating to a requester the number of supported picture presets and a number of a “best picture” preset for that display using the command byte structure 500 of FIG. 5. With reference to FIG. 1 and FIG. 7, in one embodiment of the present invention, the playout control unit 140 determines the answer to the query from the server 110 and the display 130 communicates to the server 110 the determined response.

Referring back to FIG. 7, table 706 depicts an exemplary vendor specific set command from a requester for setting a specific one of the number of supported picture presets for that display using the command byte structure 500 of FIG. 5. With reference to FIG. 1 and FIG. 7, in one embodiment of the present invention, the server 110 communicates a set command to, for example, the display 130 and ultimately the playout control unit 140 of the display 130 for attempting to set a specific one of the number of supported picture presets for the display 130.

As described above and in accordance with the present invention, the HDMI functionality and communication capabilities described above can be used to query, set and control receiver functionality. In addition, and in accordance with an embodiment of the present invention, the server 110 can provide for remote monitoring of a current status of a receiver, such as the display 130 and the display settings (e.g., power state, input/channel selection, video/audio settings, etc.). That is, the server 110 can function as a monitoring point to verify that the display 130 is configured as desired and such monitoring can be accomplished via the HDMI functionality and communication described herein.

Appendix A depicts a plurality of vendor specific commands such as query, response and set commands for controlling receiver functionality in accordance with embodiments of the present invention. For example, Appendix A provides such vendor specific commands such as Query/Set Source for requesting supported input sources and the actual selected input and for setting at least one of the supported inputs; Query/Set Contrast for requesting the actual contrast setting and setting a Contrast setting; Query/Set Volume/Mute for requesting the actual Mute status and Volume level and for setting the mute status and the volume level; Query/Set Gamma for requesting the actual gamma value and for setting a gamma value and many more.

The HDMI control functionality of the present invention can further be implemented for controlling the HDMI distribution means 370 of the system 300 for the control and optimization of a display of the embodiment described in FIG. 3. That is, the vendor specific commands of the present invention can include a Query/Set CEC/EDID Switch for requesting the status of an HDMI distribution means/switch used to select a specific Display connected to a HDMI splitter and for setting the HDMI distribution device for subsequent CEC/EDID communication.

In various embodiments of the present invention, the HDMI control functionality of the present invention can be implemented to allow limited functionality to the exterior display controls of a display including control via a remote controller. For example, in one embodiment of the present invention, a channel change button can be configured to allow a user to switch between provided media clips and/or video and audio streams communicated to a display from a server. That is, a channel change button of the display 130 can cause the STB 120 to select a different available channel from the server 110. For example, in one embodiment of the present invention, the server 110 can provide two or more media clip and/or audio channels that can be selected to be displayed on the display 130. The various channels can include varying media content to be displayed and optimized in accordance with the present invention. For example, the various channels can include sport programming (e.g., basketball games, football games, etc.), movie programming, information programming (e.g., news shows, weather channels, etc.) and the like. Each of the channels can have associated with them corresponding control signals and applications for optimizing and/or controlling the associated content as described above and in accordance with the present invention. As such, a user would be able to, using the channel up and channel down functionality of the display 130, switch between the various channels of content provided by the server 110. In accordance with the concepts of the present invention, each of the channels can be individually controlled and optimized for best viewing and/or audio conditions as described above and in accordance with the present invention.

Optionally, the concepts of the present invention can be used in conjunction with other display functionalities to produce desired display features. For example, in various embodiments of the present invention, a picture-in-picture or split-screen functionality of a display can be used to display two channels of content simultaneously, each of the channels being controlled or optimized in accordance with the present invention to be shown on the display having a desired configuration (e.g., each optimized for best viewing).

Having described various embodiments for a method, apparatus and system for the control and optimization of playout devices such as displays and speakers (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof.

1. A method for controlling a content playout device, comprising:
establishing a communication between a control device and the content playout device using a high definition multimedia interface (HDMI) application; and
controlling playout functionality of the content playout device using said established HDMI communication and vendor specific commands.

2. The method of claim 1, further comprising communicating a query to the content playout device to determine playout parameters.

3. The method of claim 2, wherein said content playout device comprises a display and said playout parameters comprise display parameters.

4. The method of claim 3, wherein said display parameters are optimized for specific content to be displayed by the display.

5. The method of claim 2, wherein said content playout device comprises a speaker and said playout parameters comprise audio output parameters.

6. The method of claim 1, wherein said control device comprises a media content server.

7. The method of claim 1, wherein said HDMI application comprises an HDMI cable having HDMI functionality, a display data channel connector for configuration and status exchange and a consumer electronics control connector for providing control functionality.

8. The method of claim 1, further comprising limiting the functionality of control buttons on at least one of the content playout device or associated remote controller for the content playout device using said established HDMI communication and vendor specific commands.

9. The method of claim 8, wherein at least one control button is assigned an alternate function.

10. The method of claim 9, wherein a channel change button is assigned to enable selection of a media content channel from a plurality of media content channels communicated to said playout device.

11. The method of claim 1, wherein said control device comprises a server in a retail advertising environment and said content playout device comprises at least one of a display and a speaker.

12. A control device for controlling a content playout device, comprising:
a memory for storing at least one of control programs and control information including vendor specific commands, media content and playout parameters of the content playout device; and
a processor for executing the control programs, the processor configured to perform the step of:
communicating media content and control information to the content playout device over an established high definition multimedia interface (HDMI) communication means for controlling playout functionality of the content playout device using said established HDMI communication means and said control information.

13. The control device of claim 12, wherein said control device comprises a server in a retail advertising environment and said media content comprises retail advertising media.

14. The control device of claim 12, wherein said HDMI communication means comprises an HDMI cable including an HDMI transmitter and an HDMI receiver, a display data channel connector and a consumer electronics control connector.

15. The control device of claim 12, wherein said processor is further configured to communicate a query to the content playout device to determine playout parameters.

16. The control device of claim 15, wherein said content playout device comprises a display and said playout parameters comprise display parameters.

17. The control device of claim 16, wherein said display parameters are optimized for specific content to be displayed by the display.

18. The control device of claim 15, wherein said content playout device comprises a speaker and said playout parameters comprise audio output parameters.

19. The control device of claim 12, wherein said processor is further configured to communicate control information intended to limit the functionality of control buttons on at least one of the content playout device or associated remote controller for the content playout device using said established HDMI communication means and vendor specific commands.

20. A content playout device, comprising:
a playout control unit including a memory for storing control programs and control information including vendor specific commands, media content and playout parameters of the content playout device and a processor for executing the control programs, the processor configured to perform the steps of:
receiving media content and control information from a control device over an established high definition multimedia interface (HDMI) communication means; and
establishing playout functionality of the content playout device in accordance with said control information received from the control device.

21. The content playout device of claim 20, wherein said processor is further configured to receive a query from the control device and respond with definitions of the playout parameters of the content playout device.

22. The content playout device of claim 21, wherein said content playout device comprises a display and said playout parameters comprise display parameters.

23. The content playout device of claim 22, wherein said display parameters are optimized for specific content to be displayed by the display.

24. The content playout device of claim 21, wherein said content playout device comprises a speaker and said playout parameters comprise audio output parameters.

25. The control device of claim 20, wherein said processor is further configured to limit the functionality of control buttons on at least one of the content playout device or associated remote controller for the content playout device in response to control information from the control device.

26. A system for controlling a content playout device, comprising:
an HDMI communication means;
a control device for communicating control information including at least vendor specific commands to the playout device via said HDMI communication means; and
a playout control unit in communication with the content playout device for receiving said control information from the control device via said HDMI communication means and establishing playout functionality of the content playout device according to said control information.

27. The system of claim 26, wherein said HDMI communication means comprises an HDMI cable, a display data channel connector and a consumer electronics control connector.

28. The system of claim 27, wherein the control device is further configured to communicate a query to the content playout device to determine playout parameters and the playout control unit is further configured to receive the query from the control device and respond with definitions of the playout parameters of the content playout device.

29. The system of claim 27, wherein the playout control unit comprises an integrated component of the content playout device.

30. The system of claim 27, wherein the control device is further configured to communicate control information intended to limit the functionality of control buttons on at least one of the content playout device or associated remote controller for the content playout device and the playout control unit is further configured to limit the functionality of the control buttons in response to the control information from the control device.
